(19) United States
(12) Patent Application Publication
(10) Pub. No.: US 2022/0039496 A1
(43) Pub. Date: Feb. 10, 2022

(54) Face Mask Structure

(71) Applicant: Chih-Ming Lee, Taichung City (TW)

(72) Inventor: Chih-Ming Lee, Taichung City (TW)

(21) Appl. No.: 16/985,528

(22) Filed: Aug. 5, 2020

(51) Int. Cl. A41D 13/11

(52) U.S. Cl. CPC A41D 13/1184

(57) ABSTRACT

A face mask structure includes a first body, a second body, a third body, and a fourth body. The first body has a perspective portion and a plurality of first snap-fit portions. Each of the first snap-fit portions has a first snap-fit groove. The second body has a plurality of first through holes, and a mask portion. The third body has a plurality of second through holes and an adjusting portion. The fourth body is assembled with the first body, the second body, and the third body. The fourth body has a mounting portion, and a plurality of second snap-fit portions. Each of the second snap-fit portions extends through each of the second through holes and each of the first through holes, and is received in the first snap-fit groove of each of the first snap-fit portions.

### BACKGROUND OF THE INVENTION

### 1. Field of the Invention

The present invention relates to a mask and, more particularly, to a face mask structure.

### 2. Description of the Related Art

A conventional face mask structure was disclosed in the Taiwanese (TW) Patent No. M465927, and comprises a mask body 1 and an eyeglass unit 2. The mask body 1 is put on the user's face and has an eyeglass mounting hole 115 corresponding to the user's eyes. The eyeglass unit 2 includes a front frame 21, a rear frame 22, and a lens 23. The rear frame 22 corresponds to the front frame 21, and is mounted in the eyeglass mounting hole 115 of the mask body 1. The lens 23 is mounted on the front frame 21.

However, the conventional face mask structure has the following disadvantages.

1. The mask body 1 includes a cover 11 that is integrally formed. The eyeglass unit 2 is combined with the mask body 1 and secured to the eyeglass mounting hole 115 of the mask body 1. A welding column 212 extends through an insertion hole 110 and is inserted into a welding hole 223. Then, the front frame 21 and the rear frame 22 are secured to and combined with the cover 11 by ultrasonic technology. Thus, after the eyeglass unit 2 is combined with the mask body 1, the eyeglass unit 2 and the mask body 1 cannot be dismantled and detached from each other, such that it is necessary to break the whole construction for separating the eyeglass unit 2 from the mask body 1. Therefore, the conventional face mask structure cannot be reused.

2. The mask body 1 and the eyeglass unit 2 are made of different materials, and their cleaning and disinfection methods are different. The mask body 1 and the eyeglass unit 2 are fixed and cannot be disassembled and separated from each other. Thus, it is difficult to clean and sterilize the mask body 1 and the eyeglass unit 2 simultaneously, thereby causing inconvenience to the user.

3. The cover 11 is made of soft material, and the eyeglass unit 2 is made of hard material and has a determined weight, such that when the cover 11 is put on the user's head, the cover 11 does not have a sufficient support.

### BRIEF SUMMARY OF THE INVENTION

The primary objective of the present invention is to provide a face mask structure that is assembled and disassembled easily and conveniently.

In accordance with the present invention, there is provided a face mask structure comprising a first body, a second body, a third body, and a fourth body. The first body is provided with a perspective portion and a plurality of first snap-fit portions. The perspective portion has a closed end and a receiving recess. Each of the first snap-fit portions has a first snap-fit groove. The second body is provided with a first slot, a plurality of first through holes, and a mask portion. The third body is assembled with the second body and is provided with a plurality of second through holes and an adjusting portion. The fourth body is assembled with the first body, the second body, and the third body. The fourth body is provided with a mounting portion, and a plurality of second snap-fit portions. The mounting portion has a receiving space and a second slot. Each of the second snap-fit portions serially extends through each of the second through holes and each of the first through holes, and is received in the first snap-fit groove of each of the first snap-fit portions, such that each of the second snap-fit portions is snap-fit into each of the first snap-fit portions.

According to the primary advantage of the present invention, each of the second snap-fit portions serially extends through each of the second through holes and each of the first through holes, and is received in the first snap-fit groove of each of the first snap-fit portions. Each of the second snap-fit portions is assembled with each of the first snap-fit portions, such that the first body, the second body, the third body, and the fourth body are assembled. The first body, the second body, the third body, and the fourth body are limited by the first snap-fit portions and the second snap-fit portions and cannot be detached from each other. Thus, the face mask structure is assembled easily.

According to another advantage of the present invention, the user applies a slight force to detach each of the second snap-fit portions from the first snap-fit groove of each of the first snap-fit portions. Then, each of the second snap-fit portions is serially detached from each of the first through holes and each of the second through holes, such that the first body, the second body, the third body, and the fourth body are disassembled and detached from each other. The first body, the second body, the third body, and the fourth body are made of different materials such that the first body, the second body, the third body, and the fourth body have different cleaning and disinfecting ways. In such a manner, the face mask structure is disassembled and separated easily, to facilitate the user cleaning and sterilizing the first body, the second body, the third body, and the fourth body.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a face mask structure in accordance with the preferred embodiment of the present invention.

FIG. 2 is a perspective view of a first body of the face mask structure in accordance with the preferred embodiment of the present invention.

FIG. 3 is a perspective view of a fourth body of the face mask structure in accordance with the preferred embodiment of the present invention.

FIG. 4 is a perspective assembly view of the face mask structure in accordance with the preferred embodiment of the present invention.

FIG. 5 is another perspective view of the face mask structure in accordance with the preferred embodiment of the present invention.

FIG. 6 is a side view of the face mask structure in accordance with the preferred embodiment of the present invention.

FIG. 7 is a cross-sectional view of the face mask structure taken along line A-A as shown in FIG. 6.

FIG. 8 is a locally enlarged view of the face mask structure taken along mark B as shown in FIG. 7.

FIG. 9 is an exploded perspective view of a face mask structure in accordance with the second preferred embodiment of the present invention.

### DETAILED DESCRIPTION OF THE INVENTION

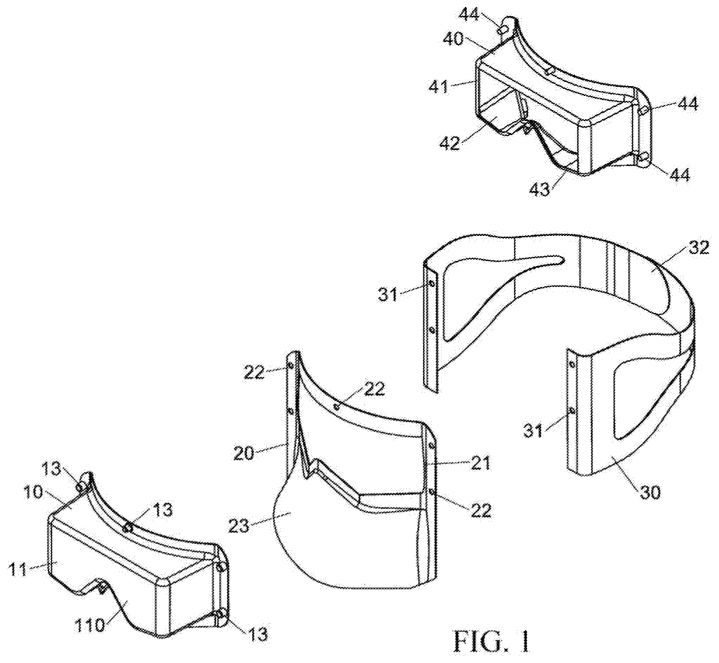

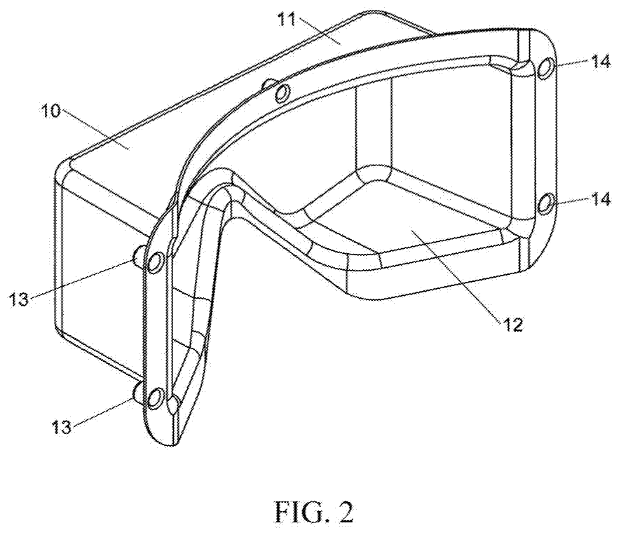

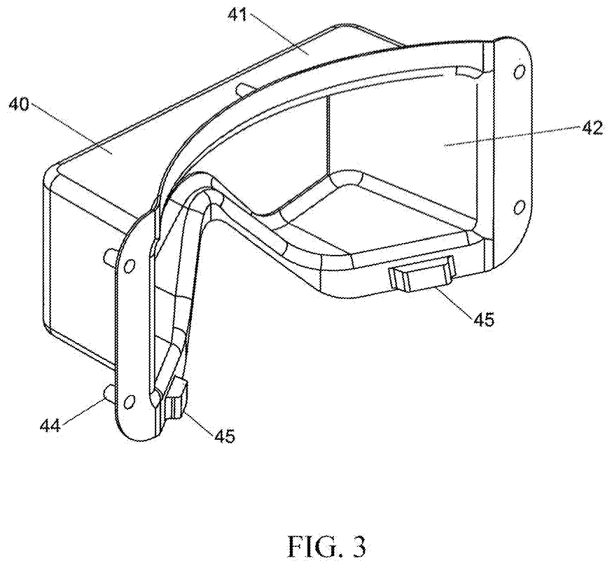

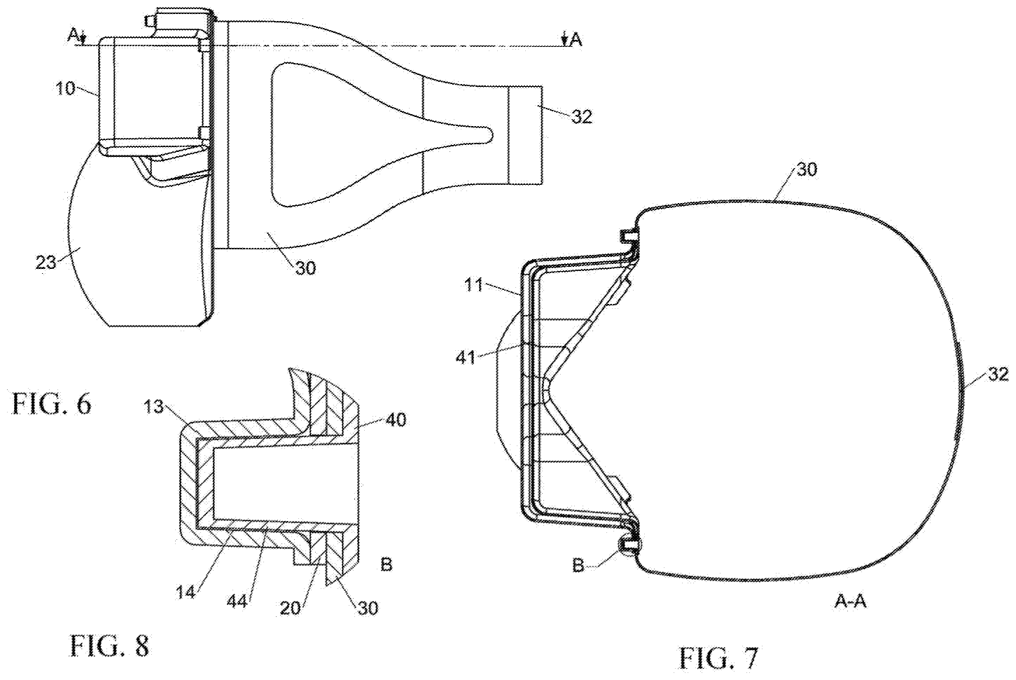

Referring to the drawings and initially to FIGS. 1-8, a face mask structure in accordance with the preferred embodiment of the present invention comprises a first body 10, a second body 20, a third body 30, and a fourth body 40.

The first body 10 is a transparent thin shell that is made of hard material. The first body 10 is provided with a perspective (or viewing) portion 11. The perspective portion 11 has a cuboid shape and has a closed end 110. The perspective portion 11 is transparent and has an interior provided with a receiving recess 12. The receiving recess 12 has an open end. The first body 10 is provided with a plurality of protruding first snap-fit portions 13. The first snap-fit portions 13 extend and protrude toward the closed end 110 and have an extending direction opposite to the open end of the receiving recess 12. The first snap-fit portions 13 are located at a periphery of the first body 10 and are arranged symmetrically. The first snap-fit portions 13 are arranged on at least two opposite sides of the first body 10. Alternatively, the first snap-fit portions 13 are arranged on at least three sides of the first body 10. Each of the first snap-fit portions 13 is hollow and has an interior provided with a first snap-fit groove 14.

The second body 20 is assembled with the first body 10. The second body 20 is provided with a first slot 21 aligning with the receiving recess 12. The first slot 21 has a shape corresponding to that of the receiving recess 12. The second body 20 is provided with a plurality of first through holes 22 each of which aligns with the first snap-fit groove 14 of each of the first snap-fit portions 13. The second body 20 is provided with a mask portion 23. The mask portion 23 covers a user's mouth and lower face. The second body 20 is made of soft cloth that is formed integrally.

The third body 30 is assembled with the second body 20. The third body 30 has a first end provided with a plurality of second through holes 31 and a second end provided with an adjusting portion 32. The second through holes 31 align with the first through holes 22 respectively. The adjusting portion 32 adjusts a length of the third body 30 to fit the user's head.

The fourth body 40 is assembled with the first body 10, the second body 20, and the third body 30. The fourth body 40 is provided with a mounting portion 41 protruding outward. The mounting portion 41 extends through the first slot 21 and is received in the receiving recess 12. The mounting portion 41 is loosely fitted into the receiving recess 12. The mounting portion 41 and the perspective portion 11 protect the user's eyes and do not affect the user's eyesight. The mounting portion 41 is transparent and has a shape and a construction the same as that of the perspective portion 11. The mounting portion 41 has a volume slightly smaller than that of the perspective portion 11. The mounting portion 41 has an interior provided with a receiving space 42. The receiving space 42 penetrates the mounting portion 41 and aligns with the user's eyes. The mounting portion 41 has an open end provided with a second slot 43 which aligns with the closed end 110. The second slot 43 is connected to the receiving recess 12 and the receiving space 42. The fourth body 40 is provided with a plurality of protruding second snap-fit portions 44. Each of the second snap-fit portions 44 serially extends through each of the second through holes 31 and each of the first through holes 22, and is received in the first snap-fit groove 14 of each of the first snap-fit portions 13. Each of the second snap-fit portions 44 is closely fit into the first snap-fit groove 14 of each of the first snap-fit portions 13. Each of the second snap-fit portions 44 is snap-fit into each of the first snap-fit portions 13, such that the first body 10, the second body 20, the third body 30, and the fourth body 40 are assembled. The first body 10, the second body 20, the third body 30, and the fourth body 40 are retained and limited by the first snap-fit portions 13 and the second snap-fit portions 44 and cannot be detached from each other. Each of the second snap-fit portions 44 is detached from the first snap-fit groove 14 of each of the first snap-fit portions 13 by a little force. The fourth body 40 is provided with two abutments 45 resting on the user's face to prevent the fourth body 40 or the face mask structure from slipping on the user's face. The two abutments 45 are close to the receiving space 42 and are located opposite to the second slot 43.

In the preferred embodiment of the present invention, the first body 10 is made of hard plastic material or acrylic material.

In the preferred embodiment of the present invention, each of the first snap-fit portions 13 has a cylindrical shape, and the first snap-fit groove 14 has a circular shape.

In the preferred embodiment of the present invention, each of the first through holes 22 has a circular shape. The first through holes 22 are arranged symmetrically. The second body 20 is made of PET (polyethylene terephthalate), waterproof material, polymerized nanotechnology bio-energy fibers, or medical grade cloth. Alternatively, the second body 20 is fluorine-free and has an anti-pollution effect. Alternatively, the second body 20 has a surface made of material that is not permeated by water or pollutant.

In the preferred embodiment of the present invention, each of the second through holes 31 has a circular shape. The adjusting portion 32 includes a loop and hook fastener (or Velcro closure), a buckle fastener or a strap fastener. The third body 30 is made of elastic cloth. The third body 30 and the second body 20 are made of the same material.

In the preferred embodiment of the present invention, each of the second snap-fit portions 44 has a cylindrical shape and extends toward the second slot 43.

In the preferred embodiment of the present invention, the second snap-fit portions 44 are arranged symmetrically.

In the preferred embodiment of the present invention, the two abutments 45 are arranged symmetrically. Each of the two abutments 45 is a rectangular block or a circular block.

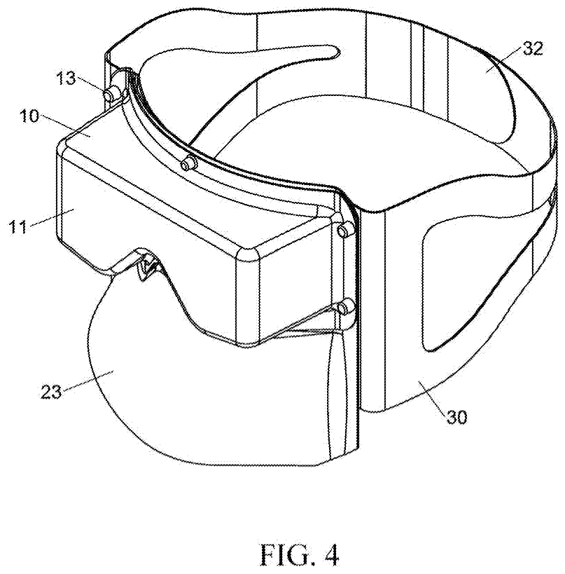

Referring to FIGS. 4-8 with reference to FIGS. 1-3, the second body 20 is assembled with the first body 10 with the first slot 21 aligning with the receiving recess 12. The third body 30 is assembled with the second body 20. The mounting portion 41 extends through the first slot 21 and is received in the receiving recess 12. Each of the second snap-fit portions 44 serially extends through each of the second through holes 31 and each of the first through holes 22, and is received in the first snap-fit groove 14 of each of the first snap-fit portions 13. Each of the second snap-fit portions 44 is closely fit into the first snap-fit groove 14 of each of the first snap-fit portions 13. Each of the second snap-fit portions 44 is snap-fit into each of the first snap-fit portions 13, such that the first body 10, the second body 20, the third body 30, and the fourth body 40 are assembled. The third body 30 is located between the second body 20 and the fourth body 40.

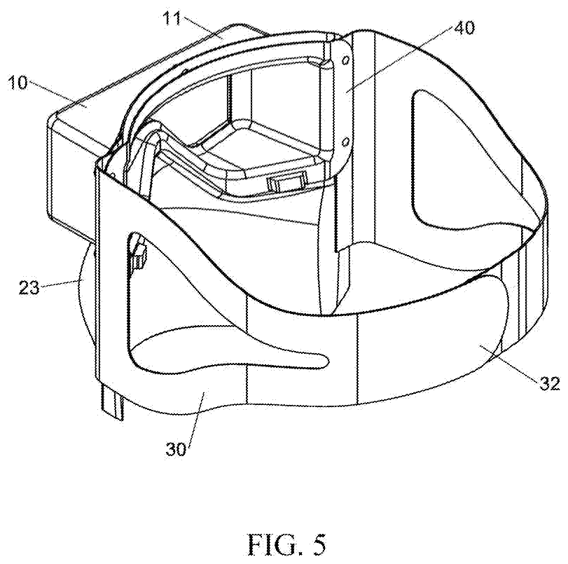

As shown in FIGS. 4 and 5, when the user wears the face mask structure, the mask portion 23 covers the user's mouth and lower face. The third body 30 is locked on the rear side of the user's head to allow the user wearing the face mask structure. The adjusting portion 32 is used to adjust the length of the third body 30, so as to fit the user's head. The receiving space 42 aligns with the user's eyes. The perspective portion 11 and the mounting portion 41 are transparent such that the perspective portion 11 and the mounting portion 41 protect the user's eyes and do not affect the user's eyesight. The two abutments 45 rest on the user's face to prevent the face mask structure from slipping freely on the user's face.

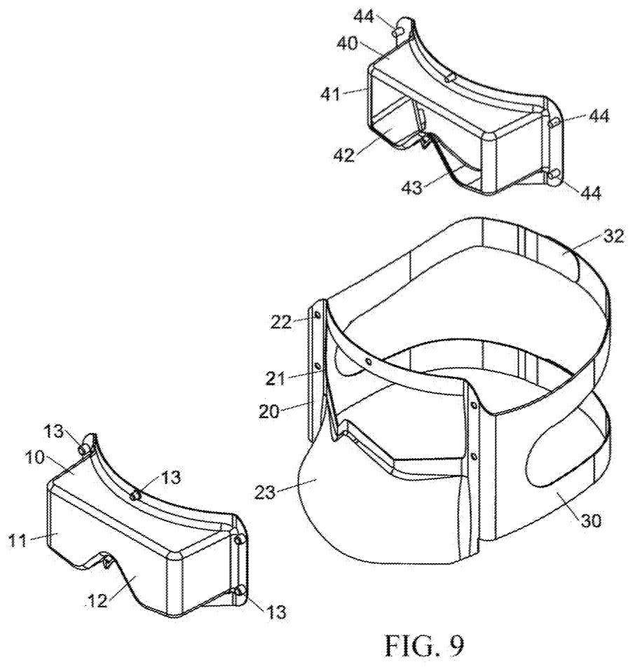

Referring to FIG. 9, the second body 20 and the third body 30 are integrated and formed integrally, and each of the first through holes 22 and each of the second through holes 31 are integrated and formed integrally.

Accordingly, the face mask structure has the following advantages.

1. Each of the second snap-fit portions 44 serially extends through each of the second through holes 31 and each of the first through holes 22, and is received in the first snap-fit groove 14 of each of the first snap-fit portions 13. Each of the second snap-fit portions 44 is assembled with each of the first snap-fit portions 13, such that the first body 10, the second body 20, the third body 30, and the fourth body 40 are assembled. The first body 10, the second body 20, the third body 30, and the fourth body 40 are limited by the first snap-fit portions 13 and the second snap-fit portions 44 and cannot be detached from each other. Thus, the face mask structure is assembled easily.

2. The user applies a slight force to detach each of the second snap-fit portions 44 from the first snap-fit groove 14 of each of the first snap-fit portions 13. Then, each of the second snap-fit portions 44 is serially detached from each of the first through holes 22 and each of the second through holes 31, such that the first body 10, the second body 20, the third body 30, and the fourth body 40 are disassembled and detached from each other. The first body 10, the second body 20, the third body 30, and the fourth body 40 are made of different materials such that the first body 10, the second body 20, the third body 30, and the fourth body 40 have different cleaning and disinfecting ways. In such a manner, the face mask structure is disassembled and separated easily, to facilitate the user cleaning and sterilizing the first body 10, the second body 20, the third body 30, and the fourth body 40.

3. The third body 30 and the fourth body 40 touch the user. In such a manner, the third body 30 and the fourth body 40 are made of two different materials to provide a support efficiently.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A face mask structure comprising:
a first body, a second body, a third body, and a fourth body;
wherein:
the first body is a transparent thin shell that is made of hard material;
the first body is provided with a perspective portion;
the perspective portion has a cuboid shape and has a closed end;
the perspective portion is transparent and has an interior provided with a receiving recess;
the receiving recess has an open end;
the first body is provided with a plurality of protruding first snap-fit portions;
the first snap-fit portions extend and protrude toward the closed end and have an extending direction opposite to the open end of the receiving recess;
the first snap-fit portions are located at a periphery of the first body and are arranged symmetrically;
the first snap-fit portions are arranged on at least two opposite sides of the first body or the first snap-fit portions are arranged on at least three sides of the first body;
each of the first snap-fit portions is hollow and has an interior provided with a first snap-fit groove;
the second body is assembled with the first body;
the second body is provided with a first slot aligning with the receiving recess;
the first slot has a shape corresponding to that of the receiving recess;
the second body is provided with a plurality of first through holes each of which aligns with the first snap-fit groove of each of the first snap-fit portions;
the second body is provided with a mask portion;
the mask portion covers a user's mouth and lower face;
the second body is made of soft cloth that is formed integrally;
the third body is assembled with the second body;
the third body has a first end provided with a plurality of second through holes and a second end provided with an adjusting portion;
the second through holes align with the first through holes respectively;
the adjusting portion adjusts a length of the third body to fit the user's head;
the fourth body is assembled with the first body, the second body, and the third body;
the fourth body is provided with a mounting portion;
the mounting portion extends through the first slot and is received in the receiving recess;
the mounting portion is loosely fitted into the receiving recess;
the mounting portion is transparent and has a shape and a construction the same as that of the perspective portion;
the mounting portion has a volume slightly smaller than that of the perspective portion;
the mounting portion has an interior provided with a receiving space;
the receiving space penetrates the mounting portion and aligns with the user's eyes;
the mounting portion has an open end provided with a second slot which aligns with the closed end;
the second slot is connected to the receiving recess and the receiving space;
the fourth body is provided with a plurality of protruding second snap-fit portions;
each of the second snap-fit portions serially extends through each of the second through holes and each of the first through holes, and is received in the first snap-fit groove of each of the first snap-fit portions;
each of the second snap-fit portions is closely fit into the first snap-fit groove of each of the first snap-fit portions;
each of the second snap-fit portions is snap-fit into each of the first snap-fit portions, such that the first body, the second body, the third body, and the fourth body are assembled;
the first body, the second body, the third body, and the fourth body are limited by the first snap-fit portions and the second snap-fit portions;
the fourth body is provided with two abutments resting on the user's face; and
the two abutments are close to the receiving space and are located opposite to the second slot.

2. The face mask structure as claimed in claim 1, wherein the first body is made of hard plastic material or acrylic material.

3. The face mask structure as claimed in claim 1, wherein each of the first snap-fit portions has a cylindrical shape, and the first snap-fit groove has a circular shape.

4. The face mask structure as claimed in claim 1, wherein:
each of the first through holes has a circular shape;
the first through holes are arranged symmetrically;
the second body is made of PET (polyethylene terephthalate), waterproof material, polymerized nanotechnology bio-energy fibers, or medical grade cloth;
the second body is fluorine-free and has an anti-pollution effect; and
the second body has a surface made of material that is not permeated by water or pollutant.

5. The face mask structure as claimed in claim 1, wherein:
each of the second through holes has a circular shape;
the adjusting portion includes a loop and hook fastener, a buckle fastener or a strap fastener;
the third body is made of elastic cloth; and
the third body and the second body are made of the same material.

6. The face mask structure as claimed in claim 1, wherein each of the second snap-fit portions has a cylindrical shape and extends toward the second slot.

7. The face mask structure as claimed in claim 1, wherein the second snap-fit portions are arranged symmetrically.

8. The face mask structure as claimed in claim 1, wherein the two abutments are arranged symmetrically. Each of the two abutments is a rectangular block or a circular block.

9. The face mask structure as claimed in claim 1, wherein the second body and the third body are integrated and formed integrally, and each of the first through holes and each of the second through holes are integrated and formed integrally.
